(19) United States
(12) Patent Application Publication
(10) Pub. No.: US 2013/0244074 A1
(43) Pub. Date: Sep. 19, 2013

(54) BATTERY PACK FOR SUPPLYING ELECTRICAL COMPONENTS, IN PARTICULAR HEATING ELEMENTS

(71) Applicants: Gerhard Kremer, Fuerstenfeld (AT); Urs Maron, Haselsdorf-Tobelbad (AT)

(72) Inventors: Gerhard Kremer, Fuerstenfeld (AT); Urs Maron, Haselsdorf-Tobelbad (AT)

(73) Assignee: THERM-IC PRODUCTS GMBH NFG. & CO. KG, Gleisdorf (AT)

(21) Appl. No.: 13/613,077

(22) Filed: Sep. 13, 2012

Related U.S. Application Data
(60) Provisional application No. 61/535,494, filed on Sep. 16, 2011.

(51) Int. Cl. H01M 2/10

(52) U.S. Cl. CPC H01M 2/1022
USPC 429/96

(57) ABSTRACT

A battery pack for supplying electrical components, in particular heating elements, includes a battery unit which has at least one battery received in a first housing part and a control unit for controlling a voltage to be output or a current to be output, the control unit having an electronic part received in a second housing part. According to the invention, the first and second housing parts are connected together detachably in a retaining position prescribed by a limit stop, contacts disposed on the first housing part in the retaining position having a conductive connection to contacts disposed on the second housing part.

### RELATED APPLICATION

This application claims the benefit, under 35 U.S.C. 119(e), of the provisional application filed Sep. 16, 2011 under 35 U.S.C. 111(b), which was granted Ser. No. 61/535,494. This provisional application is hereby incorporated by reference.

### BACKGROUND OF THE INVENTION

The invention relates to a battery pack for supplying electrical components and in particular heating elements, as are used for example in heated garments.

Various designs of such battery packs are known according to the state of the art. For example, a battery pack which has a housing with a control unit is known from EP 1 950 820 B1. Commercially available standard batteries can be inserted into this housing. As a result of the type of construction of the housing which is proposed there, it becomes particularly easy in fact to exchange the batteries, however the batteries must be removed from the housing for charging.

In addition, battery packs which are configured in one piece and comprise an internal battery and also a control unit are known. Such battery packs are in fact exceptionally convenient, however exchanging the battery is not possible. If the battery of the battery pack is defective, the entire battery pack must be exchanged. Retrofitting with a subsequently purchased larger battery is likewise impossible.

### SUMMARY OF THE INVENTION

It is the object of the invention to propose a battery pack for supplying electrical components and in particular heating elements, which pack offers great comfort, has a simple construction and enables, at the same time, easy exchange of a defective battery or one to be upgraded.

This object is achieved by a battery pack according to claim 1. Advantageous developments and embodiments are revealed in the features of the sub-claims.

As a result of the fact that a housing part is provided separately respectively for the battery unit and the control unit, the first and the second housing part being detachably connected or locked in a retaining position prescribed by a limit stop and contacts disposed on the first housing part having a conductive connection to contacts disposed on the second housing part, it becomes particularly easy and convenient to exchange the battery. Hence, subsequently purchased larger batteries can be connected to the control unit without difficulty.

In a particularly preferred embodiment, at least one locking element is connected to the housing parts in a form-fit. The locking element hereby restricts movement of the housing parts relative to each other and can preferably prevent such a relative movement entirely. As a form-fit connection or one forming a form-fit, a connection is hereby considered in which both connection partners are mutually “in the way” so that it is not possible to separate them.

In a first embodiment, the locking element can be configured as a clamping element for clamping the two housing parts together. Likewise, the locking element can be shaped as an insertion element for insertion into the first and second housing part. Of course, also a plurality of locking elements can be provided, for example at least one of the locking elements being configured as clamping element and one of the locking elements as insertion element.

In embodiments with clamping element or insertion element, the clamping element or insertion element is configured for preventing a relative movement of the first housing part relative to the second housing part. For particular preference, the clamping element can be configured as a clamping clip which engages in an outer face of the first housing part, which outer face is orientated away from the second housing part, and in an outer face of the second housing part, which outer face is orientated away from the first housing part. As a result, in particular a movement in the direction of the surface normal of the mentioned faces of the housing parts orientated away from respectively the other housing part is prevented. For engagement in the mentioned faces, the clamping clip can have corresponding projections.

A particularly reliable fixing becomes possible if at least two clamping elements are provided and are disposed overlapping on opposite sides.

Likewise, it is conducive to a reliable connection of both housing parts if the housing parts respectively have an insertion channel which is configured at least in regions as an undercut. The insertion channels are disposed such that they extend aligned with each other in a retaining position, whilst they extend offset relative to each other outside the retaining position. The insertion element is disposed in the insertion channel. An arrangement is hereby favourable in particular in which the insertion element abuts on opposite sides of the insertion channel at least over a part of the length thereof. The insertion element consequently prevents movement of the housing parts out of the retaining position because the insertion channels would hereby have to be moved out of their aligned orientation. Since the insertion element abuts however against the walls of the insertion channels, it is not possible to push it out of an aligned orientation when the insertion element is inserted.

In order to avoid undesired detachment of the insertion element, this can have a locking element. In addition, a corresponding locking recess can be provided in a base of the insertion channel so that the insertion element can be locked with at least one housing part.

Particularly good securing of the insertion element in the insertion channel is possible if a limit stop is provided at one end of the insertion channel so that the insertion element can only be inserted into the insertion channel from one side and also can be removed from the insertion channel only via this side. The locking element can then be directed away from the limit stop with an opening, detachment of a locking connection of the locking element in the locking recess being possible by engagement in this opening. Because of the arrangement of the opening, engagement in the latter generally leads to a force effect in the direction of the limit stop so that an additional force in the direction away from the limit stop is necessary in order to push the insertion element out of the insertion channel and thus to prevent renewed locking of the locking element.

In addition, a further locking element which is configured as clamping element for attaching the battery pack to a garment can be provided. This clamping element can be attached for example detachably in the insertion channel, the insertion element preferably blocking removal of the clamping element in the inserted state. For this purpose, the clamping element can protrude into an undercut region of the channel, for example on both sides of the insertion channel, the insertion element being disposed further in the middle in the channel. As a result, the insertion element blocks pushing of the clamping element into a non-undercut region of the channel and hence removal of the clamping element.

In a preferred embodiment, at least one of the housing parts preferably includes an attachment which engages in a recess of the respectively other housing part and serves for detachable locking or connection in the retaining position. The housing parts are then configured for the purpose of being moved into an insertion position in a first direction by mutual engagement of the attachment and the recess and, by moving in a second direction which is different from the first direction, being transferred from the insertion position into the retaining position. The first direction is hereby preferably the direction in which the two housing parts are disposed in the retaining position offset relative to each other. The second direction can be in particular essentially orthogonal to the first direction. There is hereby understood essentially by orthogonal that an angle between the first direction and the second direction is between 80° and 100°. A precise orthogonal arrangement of the first and second direction is however particularly preferred. In the case of such embodiments, both housing parts have form-fit elements for a form-fit connection in the retaining position after being moved. The form-fit elements can be disposed particularly preferably on the attachment and on the recess.

In a particularly suitable configuration of the form-fit elements, these are configured as a series of projections which are disposed at a spacing relative to each other and engage mutually from below in the retaining position. For particular preference, the width of the spacings between the projections is at least just as large as the width of the projections. Both housing parts can then be placed one upon the other by the projections on the first housing part being pushed through the intermediate spaces between the projections on the second housing part. The position in which the projections of the first housing part are situated respectively opposite spacings between the projection of the second housing part, both housing parts being already placed one upon the other, is defined as insertion position in such embodiments. They can be moved from the insertion position in the second direction in order to reach the retaining position. A side face of the attachment and an inner face of the recess can hereby serve as lateral limit stop such that, in the retaining position, the side face of the attachment abuts against the inner face of the recess and hence prevents further pushing in the second direction.

Particularly simple contacting between the first housing part and the second housing part and hence between the control unit and the battery unit is possible if the electrical contacts are disposed on the attachment and on the base of the recess. The contacts can be configured for example as sliding contacts. A particularly reliable electrical contacting becomes possible if at least one hollow is disposed next to the contacts of the attachment or the contacts of the recess, or a hollow is surrounded by the contacts. The contacts of the respectively other housing part can then engage in the hollow in the insertion position. By moving the housing parts from the insertion position into the retaining position, the contacts are pushed out of the hollow and onto the contacts of the respectively other housing part. Since these are at the level of the hollow, the contacts are pretensioned mutually in the retaining position.

In principle, different geometric embodiments of the battery pack are conceivable, it is however particularly preferred to configure the battery pack such that it is cuboid in its retaining position. It is likewise preferred if also each of the housing parts individually has a cuboid shape. Both cuboid housing parts are then offset relative to each other in the insertion position whilst side faces of the two housing parts extend aligned relative to each other in the retaining position so that an overall cuboid battery pack is formed. It may be mentioned that, as is normal in battery packs according to the state of the art, operating elements can be provided on the control unit. Operation by means of a remote control can also be provided. The invention correspondingly relates also to a system comprising a battery pack as described previously and a remote control, via which the control unit can be operated.

### BRIEF DESCRIPTION OF THE DRAWINGS

Embodiments of the invention are explained subsequently in more detail with reference to Figures. There are shown:

FIG. 1 a first embodiment of a battery pack in its retaining position with locking elements attached therein,

FIG. 2 the battery pack of FIG. 1 without locking elements,

FIG. 3 a first housing part of the battery pack of FIG. 1,

FIG. 4 plan view on an inner side of the second housing part of the battery pack of FIG. 1,

FIG. 5 a locking element of the battery pack of FIG. 1 which is configured as insertion element,

FIG. 6 locking element of the battery pack of FIG. 1 which is configured as clamping clip,

FIG. 7 an alternative embodiment of a clamping element,

FIG. 8 a connection between the alternative embodiment of the clamping element of FIG. 7 and the insertion element of FIG. 5, and

FIG. 9 an embodiment of a remote control for a battery pack according to the invention.

### DETAILED DESCRIPTION OF THE INVENTION

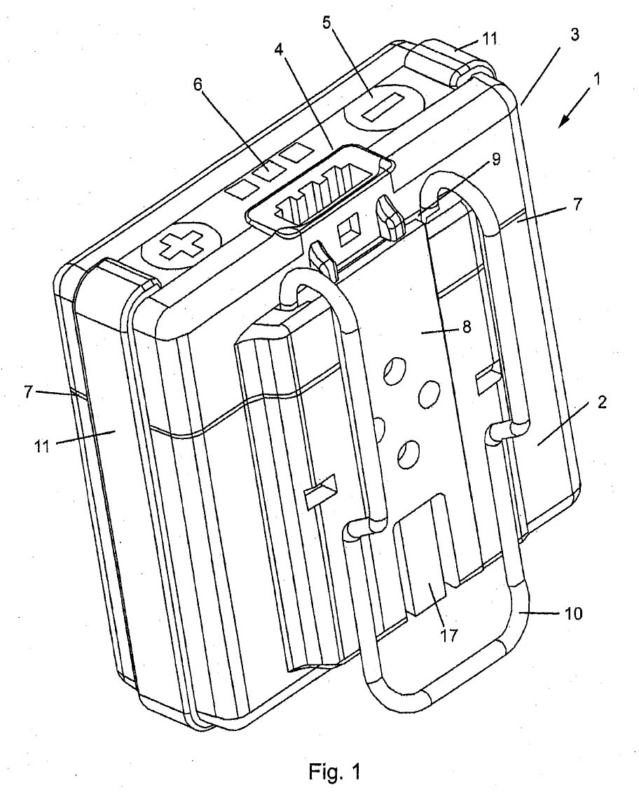

In FIG. 1, a battery pack 1 which comprises a first housing part 2 and a second housing part 3 is represented. The first housing part 2 comprises one or more batteries which are configured as lithium ion batteries in the present example. The second housing part 3 comprises an electronic control unit for controlling a current output through the terminal 4. Furthermore, the second housing part 3 includes operating elements 5 via which the output current can be adjusted, and also display elements 6, e.g. LEDs which display a current which is adjusted for output through the terminal 4. The first housing part 2 and the second housing part 3 are connected to each other along a joint 7. Furthermore, the battery pack 1 includes an insertion element 8 which is disposed in an insertion channel 9, a clamping element 10 which serves for attaching the battery pack to clothing and is clamped securely between the insertion element 8 and an edge of the insertion channel and also two clamping clips 11 which engage around the housing parts. The battery pack has an essentially cuboid configuration, the clamping clips being disposed on the narrow side faces and overlapping the narrow upper- and underside.

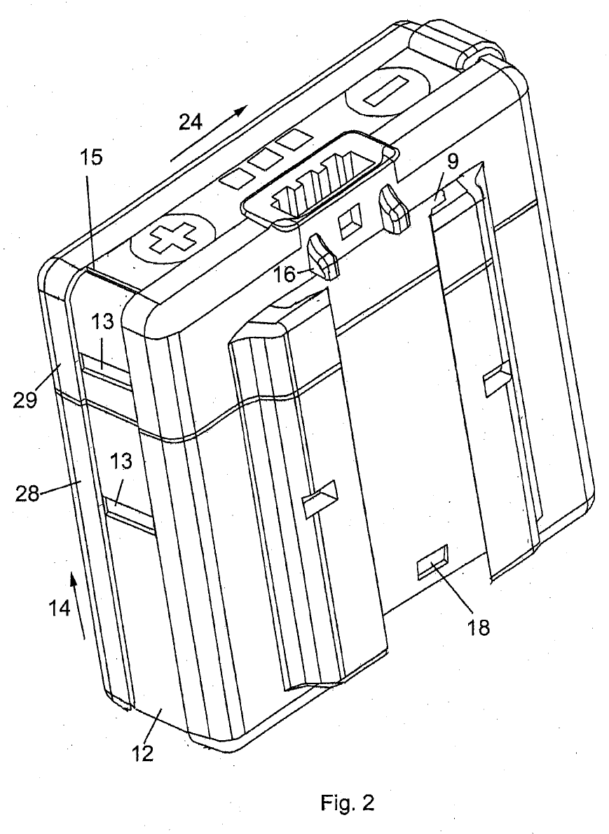

Attachment of the insertion element 8, of the clamping element 10 and of the clamping clips 11 is explained in more detail in connection with FIG. 2 which represents the battery pack 1 without the mentioned elements. In order to fit the clamping clips 11, the battery pack 1 has a groove 12 which extends over both housing parts on both sides. In the groove 12, a plurality of hollows 13, into which raised portions disposed on the inside of the clamping clips 11 can engage, are introduced. Furthermore, a hollow 15 is provided respectively on an upper side of the second housing part 3 and on the underside (not visible) of the first housing part 2. Raised portions which are disposed on the inside of the clamping clip 11 likewise engage in the hollows 15, a movement of the housing parts 2 and 3 relative to each other in a first direction 14 being consequently reliably prevented.

For the insertion element 8 and also the clamping element 10, an insertion channel 9 which is configured in regions as an undercut is provided on a large face of the cube. The clamping element 10 engages in the outer region of the insertion channel 9, whilst the insertion element 8 is disposed situated further inside in the insertion channel 9 and pushing the clamping element 10 into the inner region of the insertion channel 9 is prevented. Removal of the clamping element 10 is consequently also blocked.

Limit stops 16 are provided at one end of the insertion channel 9. As a result, the insertion element 8 can be inserted into the insertion channel 9 exclusively from the side situated opposite the limit stops 16. On the side situated opposite the limit stops 16, the insertion element 8 (cf. FIG. 1) has a locking element 17. Furthermore, a locking recess 18 in which the locking element 17 can engage is provided in the base of the insertion channel 9. In order to release the locking element 17 from the locking recess 18, the locking element 17 can be engaged from below from the side of the insertion channel situated opposite the limit stops 16. In order to remove the insertion element 8 from the insertion channel 9, it is therefore necessary to engage it from below from the side of the insertion channel situated opposite the limit stops 16 and, at the same time, to introduce a force from the direction of the limit stops. Since hence force effects from different directions are required, inadvertent release of the insertion 8 out of the insertion channel 9 is prevented in a particularly reliable manner.

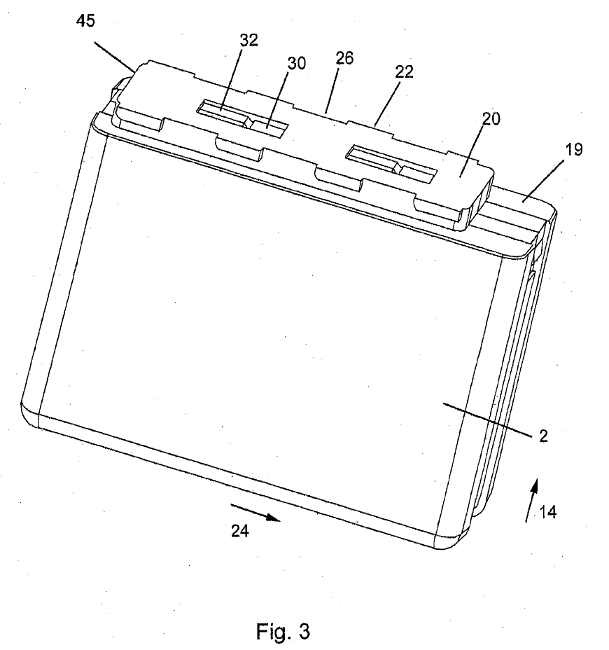

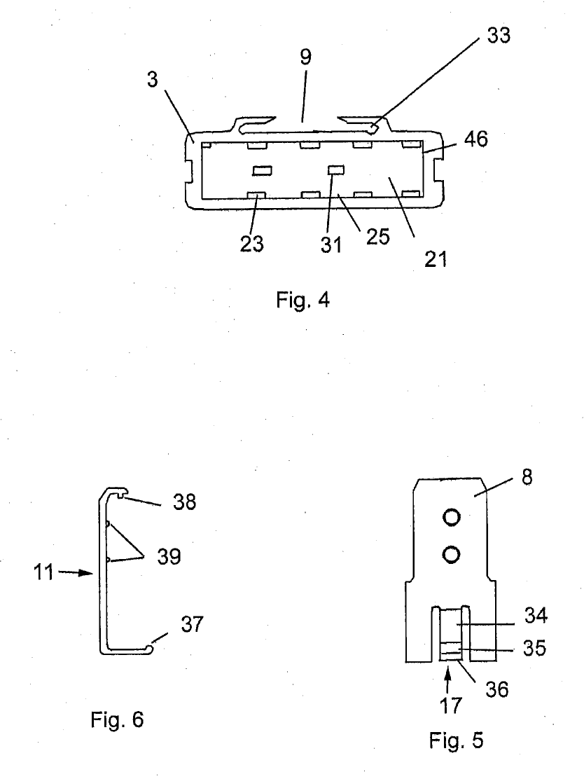

In addition to the locking elements 8, 10 and 11, another attachment is provided on one of the housing parts and a corresponding recess on respectively the other housing part in order to connect the two housing parts 2 and 3 together. This can be comprehended with reference to FIGS. 3 and 4. In FIG. 3, the first housing part 2 is represented without the second housing part 3. As can be detected, the first essentially cuboid housing part 2 has an attachment 20 on its upper narrow face 19 which is orientated towards the second housing part 3 in the retaining position represented in FIG. 1. The second housing part 3 represented in FIG. 4 has a corresponding recess 21 into which the attachment 20 can engage.

Both the attachment 20 and the recess 21 are equipped at the side with projections 22 and 23. In order to connect the two housing parts, the housing parts are placed one upon the other offset relative to each other in the lateral direction 24. The projections 22 on the first housing part 2 are hereby pushed through gaps 25 between the projections 23 of the second housing part. The projections 23 of the second housing part are on the other hand, pushed through gaps 26 between the projections 22 of the first housing part. As a result, the housing parts reach a position in which the attachment 20 already engages in the recess 21, however the housing parts still not being connected to each other in a form-fit. In this position, the side faces 28 and 29 of the first and second housing part are offset relative to each other. This position is also termed insertion position. In order to reach a position in which both housing parts are connected together securely, the housing parts are moved relative to each other laterally until the side faces 28, 29 are flush with each other and the side face 45 of the attachment abuts against a corresponding inner face 46 of the recess 21. The side face 45 and the inner face 46 hereby form a lateral limit stop which prevents further insertion after reaching the retaining position. By means of the lateral movement, the projections 22 of the first housing part and the projections 23 of the second housing part engage mutually from below so that a form-fit connection between the two housing parts is formed.

When forming the form-fit connection, an electrical contact is also formed between the first housing part 2 and the second housing part 3 and hence between the battery unit and the electronic control unit. For this purpose, contacts 30 are provided on the attachment 20 and contacts 31 on the recess 21. The contacts 31 are hereby configured as sliding contacts. A recessed region 32 is provided next to the contacts 30 on the attachment 20. If the two housing parts are moved into the insertion position, then the contacts 31 in the recess 21 firstly encounter the recessed region 32 and, upon lateral movement of the housing parts relative to each other, the contacts 31 are pushed onto the contacts 30. Since these are situated slightly higher than the recessed region 32, the contacts are mutually pretensioned so that a particularly reliable electrical connection is formed. Reference may be made to the fact that the recessed regions are not absolutely necessary. The contacts can likewise be configured such that, even in the insertion position, a pretension of the contacts in the first direction 14 is produced. The contacts are components of an electronic control unit which includes electronic elements applied on a printed circuit board and is received in the housing part 3.

The insertion channel 9 with its undercut region 33 can likewise be detected in FIG. 4.

In FIG. 5, the insertion element illustrated in FIG. 1 is represented viewed from its rear-side. As already mentioned, the insertion element 8 has a locking element 17. The locking element 17 has a region 34 in which a thickness of the material is relatively small. As a result, the region 34 has resilient properties. In the region 35, the locking element 17 is configured with increased thickness since this region serves for engagement in the locking recess 18. In the region 36 in turn, the locking element 17 has a low thickness so that it permits engagement from below from the side orientated away from the limit stops 16.

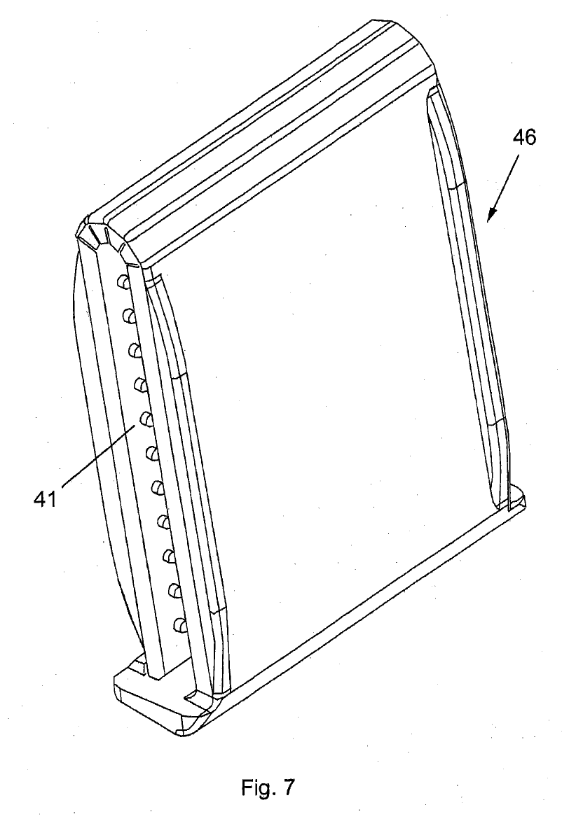

In FIG. 6, a clamping clip 11 is represented in side view. The clamping clip 11 has a first raised portion 37 which serves for engagement in an underside of the first housing part. Furthermore, a second raised portion 38 is provided, which, as shown FIGS. 1 and 2, engages in the upper side of the second housing part. In addition, further raised portions 39 are provided, which serve for engagement in the lateral recesses 13 and hence for further stabilisation of the connection between clamping clip 11 and the housing parts 2 and 3.

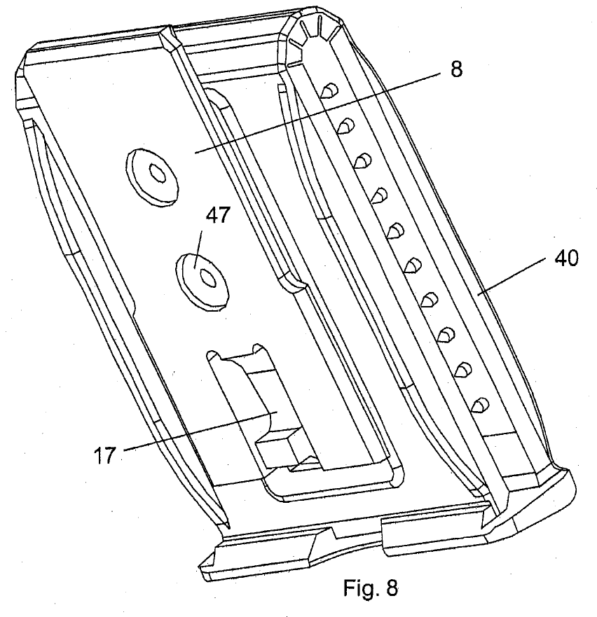

In FIG. 7, an alternative component to the clamping element 10 of FIG. 1 is represented. In contrast to the clamping element 10 of FIG. 1, the retaining element 40 in FIG. 7 is configured for the purpose of engaging around a garment on both sides. The retaining element 40 has a zigzag surface 41 which serves for engaging in the garment and hence producing a form-fit with the garment. A further difference in the retaining element 40 of FIG. 7 from the clamping element 10 of FIG. 1 is that the retaining element 40 is not attached to the insertion channel 9. Instead, the retaining element 40 is brought into engagement with the insertion element 8 by its rear-side. Hence the retaining element 40 itself does not contribute to locking of the first and second housing part. However, the insertion element 8 serves just as in the embodiment of FIG. 1 for locking the housing parts.

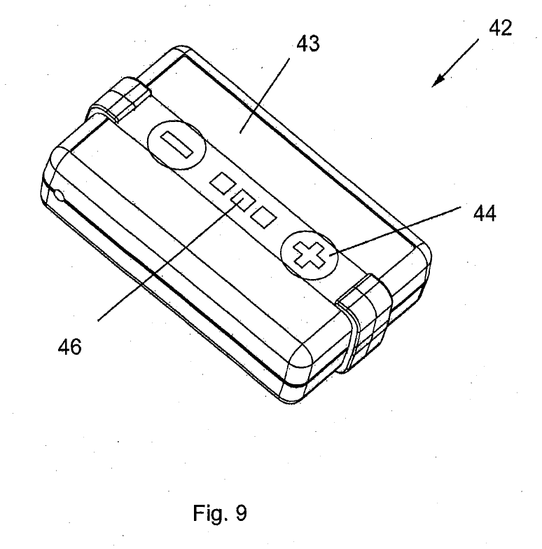

In FIG. 8, the connection between the retaining element 40 and the insertion element 8 can be detected. As represented in the Figure, the retaining element 40 is connected to the insertion element 8 by rivets 47.

In FIG. 9, a remote control 42 for a battery pack is represented. The remote control has its own housing 43 which is separate from the housing parts 2 and 3 and is fitted with operating elements 44. Furthermore, the remote control 42 includes a transmission module, not represented, via which commands input by the operating elements 44 are transmitted to the control unit. Like the second housing part, the remote control also has display elements 46 (for example LEDs), via which a currently adjusted current is displayed to the user. In a further embodiment, not represented, the remote control can also have a receiver module and a further display, information about the charge state of the battery being received by the control unit via the receiver module. This can then be displayed to the user via the further display.

Reference may be made to the fact that merely one embodiment of the invention is represented in the preceding Figures. Even if the battery pack 1 in the Figures always has an essentially cuboid configuration, it would in principle also be possible to choose a different shape configuration.

What is claimed is:

1. A battery pack for powering electrical components, in particular heating elements, comprising a battery unit which has at least one battery received in a first housing part and a control unit for controlling a voltage to be output or a current to be output, the control unit having an electronic part received in a second housing part, wherein the first and second housing part are connected together detachably in a retaining position prescribed by a limit stop, wherein contacts disposed on the first housing part in the retaining position have a conductive connection to contacts disposed on the second housing part.

2. The battery pack according to claim 1, wherein at least one locking element is connected to the housing parts in a form-fit which restricts movement of the housing parts relative to each other.

3. The battery pack according to claim 2, wherein the locking element is configured as a clamping element for clamping the housing parts together and/or an as insertion element for insertion into the first and second housing part.

4. The battery pack according to claim 3, wherein the clamping element is configured for preventing a relative movement of the first housing part relative to the second housing part.

5. The battery pack according to claim 3, wherein at least two clamping elements are disposed overlapping the housing parts on opposite sides.

6. The battery pack according to claim 3, wherein the housing parts respectively have an insertion channel, which is configured at least in regions as an undercut, and are disposed aligned with each other in the retaining position, the insertion element being able to be introduced into the insertion channels such that the housing parts are locked against a relative movement.

7. The battery pack according to claim 6, wherein the insertion element can be locked by a locking element for engagement in a corresponding locking recess in a base of the insertion channel with at least one housing part.

8. The battery pack according to claim 7, wherein a limit stop is disposed at one end of the insertion channel such that the insertion element can be inserted into the insertion channel only from the side situated opposite the limit stop.

9. The battery pack according to claim 2, wherein the locking element is configured as a clamping element for attaching the battery pack to a garment or includes such.

10. The battery pack according to claim 9, wherein the clamping element is attached detachably in the insertion channel.

11. The battery pack according to claim 1, wherein at least one of the housing parts includes an attachment for engagement in a recess of the respectively other housing part and detachable locking in the retaining position, the housing parts being configured for the purpose of being moved into an insertion position in a first direction by mutual insertion of the attachment and the recess and, by moving in a second direction which is different from the first direction, being transferred from the insertion position into the retaining position, both housing parts having form-fit elements for a form-fit connection in the retaining position after being moved.

12. The battery pack according to claim 11, wherein the form-fit elements are configured as a series of projections which are disposed at a spacing relative to each other and engage mutually from below in the retaining position.

13. The battery pack according to claim 1, wherein the electrical contacts are disposed on the attachment and on the base of the recess.

14. The battery pack according to claim 13, wherein a hollow is disposed next to the contacts of the attachment or of the recess or a hollow is surrounded by the contacts, in which hollow the contacts in the recess or of the attachment engage in the insertion position, the contacts in the recess or of the attachment being pretensioned in the retaining position relative to the respectively other contact.

15. The battery pack according to claim 1, wherein the housing parts when joined produce a cuboid shape.

16. The battery pack according to claim 3, wherein the clamping element is configured for preventing a relative movement of the first housing part relative to the second housing part, such that the clamping element as clamping clip engages in an outer face of the first housing part, which outer face is orientated away from the second housing part, and in an outer face of the second housing part, which outer face is orientated away from the first housing part.

17. The battery pack according to claim 8, wherein the locking element is configured such that it can be pushed out of the locking recess by levering from below from the side situated opposite the limit stop.

18. The battery pack according to claim 9, wherein the clamping element is attached detachably in the insertion channel, the insertion element being disposed to block the clamping element.

19. The battery pack according to claim 1, wherein the housing parts when joined produce a cuboid shape, the housing parts respectively individually having a likewise cuboid configuration.
